(19) United States
(12) Patent Application Publication
(10) Pub. No.: US 2016/0353182 A1
(43) Pub. Date: Dec. 1, 2016

(54) METHOD FOR SYNCHRONISING METADATA WITH AN AUDIOVISUAL DOCUMENT BY USING PARTS OF FRAMES AND A DEVICE FOR PRODUCING SUCH METADATA

(71) Applicant: THOMSON LICENSING, Issy les Moulineaux (FR)

(72) Inventors: Pierre Hellier, Thorigne Fouillard (FR); Franck Thudor, Rennes (FR); Lionel Oisel, La Nouaye (FR)

(21) Appl. No.: 15/108,569

(22) PCT Filed: Dec. 22, 2014
(86) PCT No.: PCT/EP2014/079011

§ 371 Date: Jun. 27, 2016

(30) Foreign Application Priority Data
Dec. 27, 2013 (FR) 1363624

(51) Int. Cl. H04N 21/858; H04N 21/235; H04N 21/44; H04N 21/435; H04N 21/81; H04N 21/84; G11B 27/10; H04N 21/43

(52) U.S. Cl. CPC H04N 21/858; G11B 27/10; H04N 21/235; H04N 21/4307; H04N 21/435; H04N 21/8133; H04N 21/84; H04N 21/44008

(57) ABSTRACT

The invention relates to a method and a device for synchronising metadata associated by a first signature to a first version of an audiovisual document, with a second version of this audiovisual document. The method is characterised in that it synchronises the metadata with the second version of the audiovisual document from a second signature detected in the portion of the second version of the audiovisual document, said portion of the second version of the audiovisual document being obtained by detecting the first signature in the second version of the audiovisual document. In this way, the precision of the synchronisation between the two items of video content carried out by the first signature is improved by the second signature, and new, more accurate metadata is created.

### 1. FIELD OF THE INVENTION

The field of this invention is that of the synchronisation of metadata between multiple items of video content. More specifically, the invention relates to cases where the synchronisation must be carried out with great precision by taking into account a portion of the image of video content.

### 2. PRIOR ART

The invention is situated in the domain of audiovisual document production and the capacity to associate metadata with such documents. During the “post-production” phase, during which an audiovisual document is made, it undergoes significant modifications. During some steps, metadata is associated with this document. The metadata enriches the content by providing it, for example, with interactivity, subtitling, information about the actors or objects appearing in the video, dubbing, websites, etc. Generally, this metadata is associated with a time of appearance of a certain item of visual content, for example the presence of a character in the image.

During post-production, this document is modified and becomes a second, more complete video document. For example, some scenes are cut, others are reframed, new soundtracks corresponding to other languages are added, and different types of versions are produced (ex. versions intended to be shown in a plane). The metadata associated with a first version is no longer associated with subsequent versions. It is therefore necessary to create a new association between this same metadata and second documents.

One obvious solution is to repeat the same association method as for the first document and to associate the same metadata to the same video portions. The method can be tedious if it is done manually, so it is best to do it automatically using the same video markers. However, the video content of the second document may be changed, making those video markers associating the metadata to the first document incorrect. One solution is to use the audio markers, which are more accurate than video markers, but if the audio content is changed in the second document, the markers are no longer operational. This is the case, for example, when dubbing speech. A camera films a wide shot of a person speaking about a topic in some language. This audiovisual document can be improved by framing on the upper part of his body and by adding different audio content for dubbing in other languages. In this example, a video marker characterised by the signature of the outline of the person appearing in the first version becomes inaccurate for associating the corresponding metadata in a second version of that document. It is not possible to use an audio marker because the audio content is different due to the dubbing.

There is therefore a real need to improve the techniques for synchronising metadata associated with multiple audiovisual documents.

### 3. SUMMARY OF THE INVENTION

For this purpose, the invention proposes a new solution, in the form of a method for synchronising at least one first metadata associated with an audiovisual document. This at least one first metadata including a first signature of an audio and/or video frame in a sequence from a first document. Portions of the first document are reused to create a second audiovisual document, in which the at least one first metadata is no longer associated.

Specifically, the method includes:
an association of at least one second metadata with the first document, this at least one second metadata comprising a second signature of the visual content extracted from a portion of a frame from said sequence of the first document,
a detection of the first signature in a sequence of the second audiovisual document,
a detection of the second signature in the sequence of the second audiovisual document and synchronisation of the first metadata with the second document using this second signature.

In this way, the precision of the synchronisation between the two items of video content carried out by the first signature is improved by the second signature, and new, more accurate metadata is created.

According to a first embodiment, the method comprises a determination of a geometric shape surrounding the portion of frame in the sequence in the first document, and the visual content of this geometric shape is used to produce the second signature. In this way, the signature calculation is limited to a certain area of the frame in the first document.

According to another embodiment, the method comprises a search in each image of the sequence for a particular geometric shape and an extraction of a signature from the video content contained in the geometric shape, this signature being compared to the second signature. In this way, the detection of the second signature is limited to a certain area of the frame in the first document.

According to another embodiment, the signature extracted from the visual content is made over a concatenation of areas of interest, the second metadata including the spatial relationship unifying the different areas of interest used to calculate said signature. In this way, the second signature takes into account multiple areas of the image that have a particular characteristic, which adds precision to the detection step and improves the synchronisation.

According to another embodiment, the first signature is calculated from audio data. In this way, the detection of the first signature requires less computing power.

According to a hardware aspect, the invention relates to a device for synchronising an audiovisual document and metadata including a means for reading a first audiovisual document associated to at least one first metadata including a first signature from an audio and/or video frame from a sequence from said first document, the portions of said first document being reused to create a second audiovisual document in which the at least one first metadata is no longer associated. Because the means for reading said device reads a data item associating at least one second metadata with the first document, this at least one second metadata comprising a second signature of the visual content extracted from a portion of a frame from said sequence of the first document, The device further comprises a means for detecting the first signature in a sequence from the second audiovisual document and the second signature in the sequence from the second audiovisual document, as well as a means for synchronising the first metadata with the second document by using this second signature.

According to another hardware aspect, the invention also relates to a computer program containing instructions for implementing the method for synchronisation between audiovisual content and the metadata described according to any one of the embodiments described above, when said program is executed by a processor.

### 4. LIST OF FIGURES

Other characteristics and advantages of the invention will emerge more clearly upon reading the following description of a particular embodiment, provided as a simple non-restrictive example and referring to the annexed drawings, wherein:

FIG. 1 shows an example flowchart of the steps for implementing the method according to a preferred embodiment of the invention,

FIG. 2 shows a diagram of an example sequencing of various operations to synchronise two documents,

FIG. 3 shows highly similar images, these images being associated with metadata.

### 5. DESCRIPTION OF AN EMBODIMENT OF THE INVENTION

5.1 General Principle

The general principle of the invention resides in a method for synchronising a first metadata associated with an audiovisual document, this first metadata comprising a first signature of an audio and/or video frame from a sequence from the first document. Portions of the first document are reused to create a second document, in which the first metadata is no longer associated. A second metadata is first associated with the first document, and this at least one second metadata comprises a second signature of the visual content extracted from a portion of a frame from the sequence of the first document. Then, the first signature is detected in a sequence from the second audiovisual document. The second signature is then detected in the sequence from the second audiovisual document, and the first metadata is synchronised with the second document using this second signature.

In this way, the precision of the synchronisation between the two items of audiovisual content carried out by the first signature is improved by the second signature, and new, more accurate metadata is created.

5.2 General Description of an Embodiment

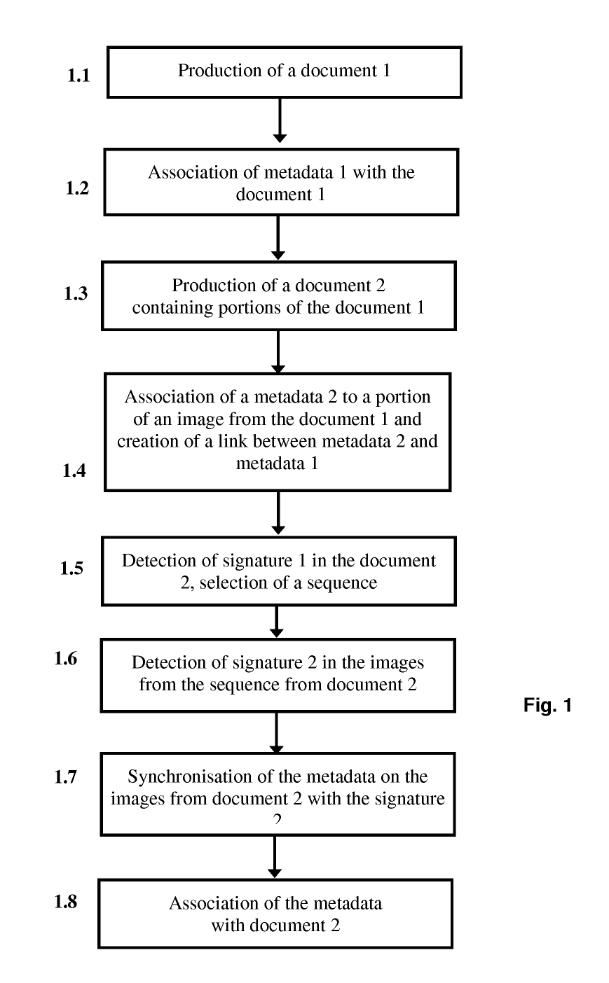

FIG. 1 shows an example flowchart of the steps for implementing the method according to the invention. This flowchart is advantageously implemented in an audiovisual document production apparatus receiving audiovisual content and metadata as input and generating other audiovisual documents with associated metadata.

Initially, in step 1.1, an item of audiovisual content is produced according to a first version. Although the invention hereafter is described as part of the production of a film, it applies to any audiovisual document, including a speech, a documentary, a reality television show, etc. This first version can be the direct result of the editing of the theatrical version of the film. From this first version, second versions will be produced for foreign countries (with different languages), a DVD version, a long version, an airline version, and even a censored version.

During the editing phase, metadata is generated and associated by signature to the audio and/or visual video content. Metadata can be represented in the form of a data structure comprising a payload, a signature triggering the presentation of the payload, and administrative data. The payload characterises the information that is communicated to someone at a certain time identified by at least one image from the document. This person may be a viewer during the playback of the audiovisual content, and the payload of the may be text that displays by request, a website for connecting at some point during the playback, information about the document script (actor, director, music name, haptic data for the actuator control, etc.). The presentation of the payload may be intended for people during the editing phase, and the payload may be markers to help with the dubbing (lip, semi-lip, phrase start and end, etc.), colour processing (calibration) associated with that particular frame, and textual annotations describing the artistic intent (emotion of the scene, for example).

The presentation of the metadata payload must happen at a very specific time in the associated audiovisual document, and such time is set by a signature of the content (or “fingerprinting”). When this signature is detected in the audio and/or visual content, the payload is presented to the person. The signature is a numeric value obtained from compressed or uncompressed audio and/or video information from a first version of the audiovisual document. The administrative information specifies the conditions for presenting the payload and may be metadata (text to display, site to contact, soundtrack to launch, etc.). During step 1.2, a metadata 1 is associated to the document 1, this metadata containing a signature 1.

During the production phase, a second document (“document 2”) is produced using portions of the first document (step 1.3). Typically, sequences of images are cut or reframed, audio content is added, or visual elements are embedded in the video, etc. During this phase, the metadata 1, which was previously produced and associated to the first document, is no longer synchronised with the content of the document 2. The present invention makes it possible to automatically resynchronise some or all of the metadata 1. In some cases, the markers that can calculate the first signatures no longer exist or are too imprecise. This invention creates second metadata that will be associated to the first document and will synchronise the first metadata with the second document.

For this, during step 1.4, second metadata is produced, a link is created with the metadata 1, and all of it is associated with the first document. The signature from this second metadata (“signature 2”) applies to a portion of the visual frame from an image at least of the first document. This portion is determined by the content of a geometric shape defined by its shape (round, rectangular, square, etc.) and its coordinates in the frame from the image. For example, this portion is a rectangular frame containing the face of a person. The link between the first and second metadata allows them to be associated so that the payload of the second is also that of the first.

During a further step, the metadata of document 1 must be associated and synchronised to document 2. Initially, the signature 1 is detected in the plurality of frames from the document 2, such frames forming sequences (step 1.5). This first detection is not precise enough to associate with the payload from the metadata 1 because the same signature is found in multiple frames at different times in the document 2. Using the link between the metadata 1 and 2, the second metadata is then analysed in relation to the frames present in the sequences and the signature 2 is extracted. During step 1.6, the signature 2 is detected in a portion of the frame comprising each image from a previously determined sequence. Note that the signature is verified on a portion of the image, and this processing requires less computing power.

The portion of the frame is determined by the information contained in the metadata 2. The payload of the metadata 1 is then synchronised with the document 2 (step 1.7) using the signature 2. Then, the new metadata is associated to the document 2 by indicating the payload from metadata 1 and the signature 2.

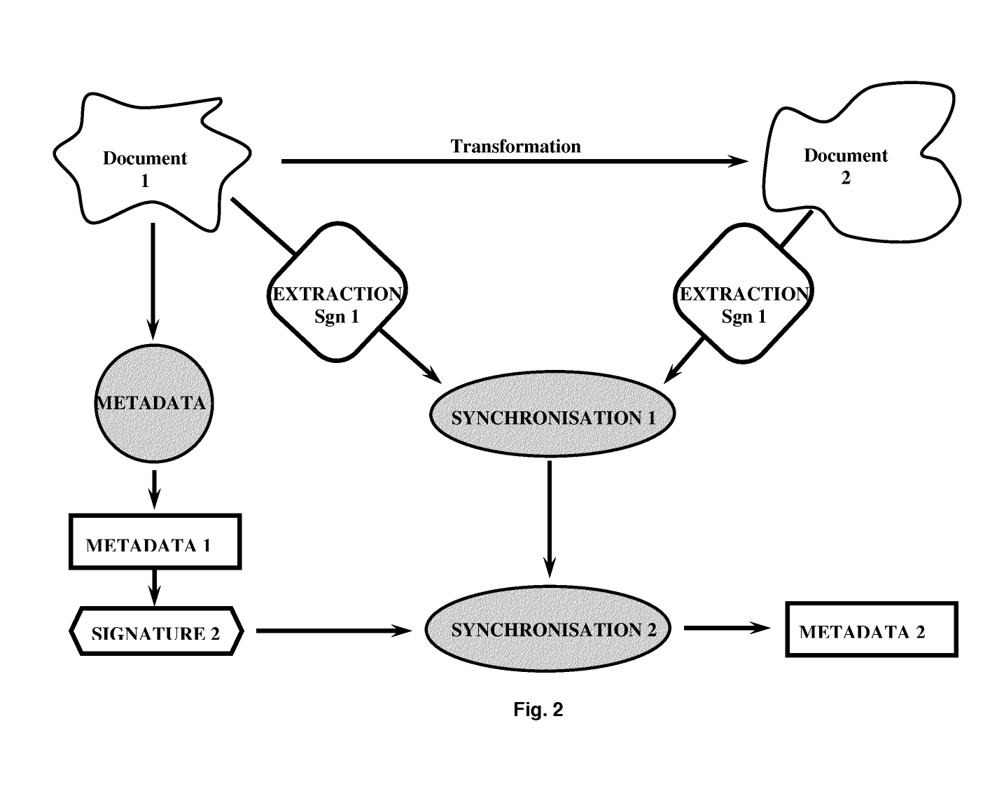

FIG. 2 shows an example sequencing of various operations to synchronise two documents. A document 1 is enriched with a plurality of metadata “METADATA 1”, and this first metadata is synchronised in the document 1 by signatures Sgn 1 based on an item of audio and/or video content from the document 1. For the purpose of future processing, this first metadata is linked to a second, more precise signature, which is calculated from a portion of the visual frame from an image at least from the first document. Advantageously, this portion of the visual frame has a relationship with the payload of the metadata. For example, the portion is a frame surrounding the face of a character who is speaking, and the payload is the textual content of this character's words.

A second document is created, which includes video portions of the first document, but no longer has associations with the metadata. This second document is analysed with the first signature, which thus makes it possible to determine a certain number of images for the approximate synchronisation of the metadata 1, and these images having the first signature form a plurality of image sequences that are candidates for the precise synchronisation. Then, within these candidate sequences, visual data is extracted in a portion of a visual frame, and this portion is defined by a geometric shape. This geometric shape is called a “bounding box”. When the second signature is detected within the portion of frame from certain images, those images are associated with the payload of the first metadata. In this way, new metadata “METADATA 2” are generated by associating a payload with the second signature.

During the rough synchronisation in step 1.5 (see FIG. 1), a certain number of images, a number marked N, are candidates. The precise synchronisation, which is carried out in step 1.6, illustrated by FIG. 2, consists of verifying whether the second signature is found in these N images. This verification can be done according to multiple embodiments. According to a first embodiment, all of the geometric shapes are analysed—or M, their mean number per image—and a signature is extracted for each shape. When then get N×M extracted signatures, which are compared with the signature read from METADATA 2. The extracted signature providing the shortest distance is chosen, and the synchronisation is carried out on the image that contains this geometric shape from which this signature is extracted. This embodiment has the advantage of being exhaustive, but it requires significant computing power.

According to another embodiment, the signature is made by concatenating multiple points of interest with their local descriptors. The size of the signature reduced to the specified geometric shape (“bounding box”) has a smaller size than that of the document 2. The spatial relationship between the points of interest must then be encoded to ensure that the correct descriptors are compared. Similar elements between the two images can be detected using the SIFT (“Scale-Invariant Feature Transform”) method. According to this method, the signatures are descriptors of the images to be compared. These descriptors are numeric information derived from the local analysis of an image characterising the visual content of the image as independently as possible from the scale (zoom and resolution of the sensor), framing, viewing angle, and exposure (brightness). In this way, two photographs of the same object will have every chance of having similar SIFT descriptors, especially if the shot times and angles are close.

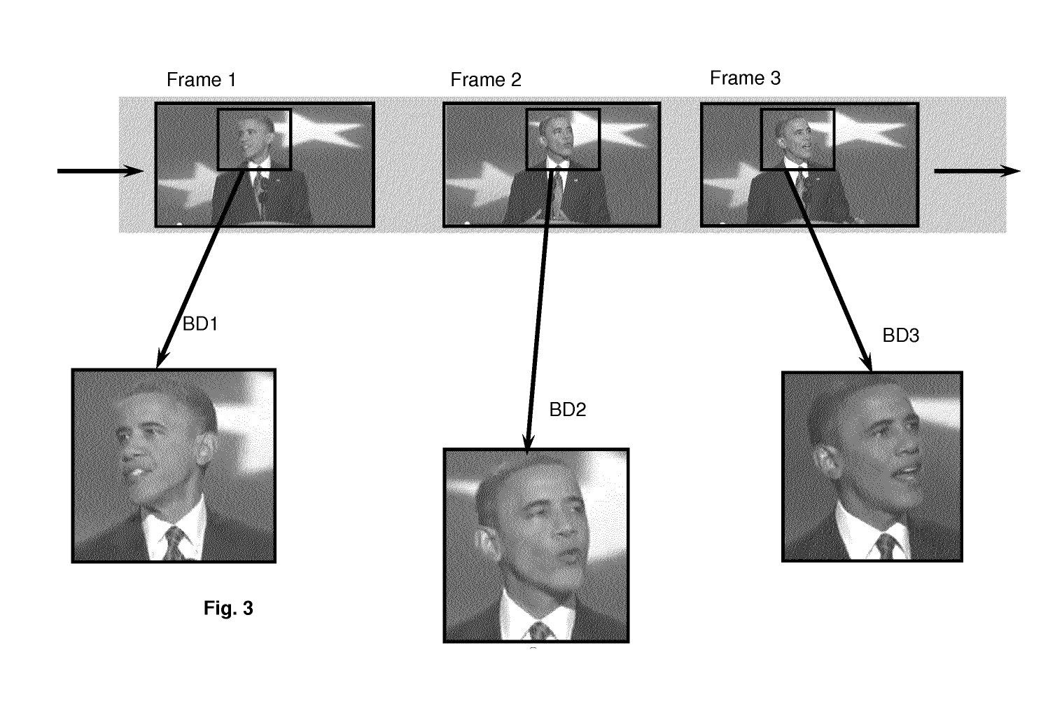

FIG. 3 shows a sequence of images that have great similarities, and these three images are represented by their frames: Frame 1, Frame 2, and Frame 3. These images are extracted from a speech by U.S. President Obama. It may be noted that very large similarities exist between these images, such as the setting behind the character. A signature based on the entire image might not be sufficiently discriminating to identify the Frame 1, Frame 2, or Frame 3 and is thus incapable of presenting the metadata at the right time. A means to discriminate each frame more effectively involves focusing on an image element that varies the most during the sequence illustrated at the top of FIG. 3, because this element is the person's face. For this, and according to a preferred embodiment of the invention, a software module detects the presence of a face in each frame of images and locates this detected face in a shape, such as a rectangular shape. The content in this shape is used to calculate a second signature. In the case of FIG. 3, three shapes BD1, BD2, and BD3 were created for the purposes of associating them to three payloads specified in the three metadata corresponding to images 1, 2, and 3. When a signature associated with the visual content of the shape is detected, the corresponding metadata is presented.

In the foregoing, the first signatures are based on all types of content: audio, photo, and visual. The second signatures, which provide better synchronisation, are based on exclusively visual content.

While the present invention was described in reference to particular illustrated embodiments, said invention is in no way limited to these embodiments, but only by the appended claims. It should be noted that changes or modifications to the embodiments previously described can be contributed by those in the profession, without leaving the framework of the present invention.

Of course, this invention relates to a device having an adapted processor to read a first audiovisual document associated to at least one first metadata including a first signature from an audio and/or video frame from a sequence from said first document, the portions of said first document being reused to create a second audiovisual document in which the at least one first metadata is no longer associated. The processor reads data associating at least one second metadata with the first document, this at least one second metadata comprising a second signature of the visual content extracted from a portion of a frame from said sequence of the first document. The processor detects the first signature in a sequence from the second audiovisual document and the second signature in the sequence from the second audiovisual document and synchronises the first metadata with the second document by using this second signature.

Such a device, not shown in the figures, is for example a computer or post-production device comprising computing means in the form of one or more processors.

1. A method of synchronising at least one metadata associated with a first version of an audiovisual document, with a second version of said audiovisual document, said at least one metadata being synchronized with said first version by a first signature of a first portion of said first version, the method comprising:
associating at least one second metadata with the first version of the audiovisual content, said second metadata being synchronized with said first version by a second signature of a second portion of frames of said first portion,
detecting the first signature in portions of said second version,
detecting the second signature in a portion of frames of said portions of said second version,
Synchronizing the metadata with said portions of the second version of the audiovisual document.

2. The method according to claim 1, in which the second portion of said first version of the audiovisual document from which the second signature is extracted is delimited by a geometric shape.

3. The method according to claim 2, in which said portions of the second version of the audiovisual document are obtained by detecting the geometric shape in the second version of the audiovisual document, and the second signature is then detected from the content of the second version of the audiovisual document then delimited by this geometric shape.

4. A device configured to synchronize at least one metadata associated with a first version of an audiovisual document, with a second version of said audiovisual document, said at least one metadata being synchronized with said first version by a first signature of a first portion of said first version, the device comprising a processor configured to:
associate at least one second metadata with the first version of the audiovisual content, said second metadata being synchronized with said first version by a second signature of a second portion of frames of said first portion,
detect the first signature in portions of said second version,
detect the second signature in a portion of frames of said portions of said second version,
Synchronise the metadata with said portions of the second version of the audiovisual document.

5. he device according to claim 4, in which the second portion of said first version of the audiovisual document from which the second signature is extracted is delimited by a geometric shape.

6. The device according to claim 5, in which said portions of the second version of the audiovisual document are obtained by detecting the geometric shape in the second version of the audiovisual document, and the second signature is then detected from the content of the second version of the audiovisual document then delimited by this geometric shape.

7. A computer program product comprising program code instructions for implementing the synchronisation method according to claim 1, when the program is executed by a processor.
